(19) United States
(12) Patent Application Publication
(10) Pub. No.: US 2018/0094185 A1
(43) Pub. Date: Apr. 5, 2018

(54) Cellulose or Cellulose Derivative Including Grafted Acrylamide or Acrylic Acid Groups for Treatment of Subterranean Formations

(71) Applicant: Halliburton Energy Services, Inc., Houston, TX (US)

(72) Inventors: Dipti Singh, Kingwood, TX (US); Prashant D. Chopade, Kingwood, TX (US)

(73) Assignee: Halliburton Energy Services, Inc., Houston, TX (US)

(21) Appl. No.: 15/563,602

(22) PCT Filed: Apr. 22, 2015
(86) PCT No.: PCT/US2015/027057

§ 371 Date: Oct. 1, 2017

(51) Int. Cl. C09K 8/68; C09K 8/66; C09K 8/035

(52) U.S. Cl. CPC C09K 8/68; C09K 8/665; C09K 2208/32; C09K 2208/26; C09K 8/035

(57) ABSTRACT

Various embodiments disclosed relate to a cellulose or cellulose derivative, the cellulose or cellulose derivative including grafted acrylamide or acrylic acid groups for treatment of subterranean formations. In various embodiments, the present invention provides a method of treating a subterranean formation including placing in the subterranean formation a composition including a cellulose or cellulose derivative, the cellulose or cellulose derivative including grafted groups. The grafted groups are selected from the group consisting of a) grafted acrylamide groups, b) grafted acrylic acid groups or a salt or a substituted or unsubstituted (C₁-C₁₀)hydrocarbyl ester thereof, and c) a combination thereof.

### BACKGROUND

Borate-crosslinked polysaccharide-based fluids such as guar-based fluids are widely used for fracturing application due to lower cost, shear-tolerance reliability, and low friction. However, guar-based fluids yield insoluble residue which is detrimental to the production of hydrocarbons. Alternative fluids with lower amounts of residue require higher treating pressure compared to conventional guar and derivatized guar system, preventing their use in higher rate hybrid jobs, such as in unconventional reservoirs.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can itself be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “heterocyclyl” as used herein refers to aromatic and non-aromatic ring compounds containing three or more ring members, of which one or more is a heteroatom such as, but not limited to, N, O, and S.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group, respectively, that includes carbon and hydrogen atoms. The term can also refer to molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are positive integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “solvent” as used herein refers to a liquid that can dissolve a solid, liquid, or gas. Non-limiting examples of solvents are silicones, organic compounds, water, alcohols, ionic liquids, and supercritical fluids.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers. In a polymer having multiple repeating groups, wherein the repeating groups can be in random or block copolymer arrangement, some of the repeating groups can have random arrangement with respect to one another, while other repeating groups can have a block arrangement with respect to one another, within a polymer molecule. In other embodiments, a polymer molecule includes only a block arrangement of repeating units, or only a random arrangement of repeating units.

The term “copolymer” as used herein refers to a polymer that includes at least two different repeating units. A copolymer can include any suitable number of repeating units.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product or fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

In various embodiments, salts having a positively charged counterion can include any suitable positively charged counterion. For example, the counterion can be ammonium(NH₄⁺), or an alkali metal such as sodium (Na⁺), potassium (K⁺), or lithium (Li⁺). In some embodiments, the counterion can have a positive charge greater than +1, which can in some embodiments complex to multiple ionized groups, such as Zn²⁺, Al³⁺, or alkaline earth metals such as Ca²⁺ or Mg²⁺.

In various embodiments, salts having a negatively charged counterion can include any suitable negatively charged counterion. For example, the counterion can be a halide, such as fluoride, chloride, iodide, or bromide. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some embodiments, a counterion can have a negative charge greater than −1, which can in some embodiments complex to multiple ionized groups, such as oxide, sulfide, nitride, arsenate, phosphate, arsenite, hydrogen phosphate, sulfate, thiosulfate, sulfite, carbonate, chromate, dichromate, peroxide, or oxalate.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Method of Treating a Subterranean Formation.

In some embodiments, the present invention provides a method of treating a subterranean formation. The method includes placing the composition in the subterranean formation. The composition includes a cellulose or cellulose derivative, the cellulose or cellulose derivative including grafted groups. The grafted groups on the cellulose or cellulose derivative are selected from the group consisting of a) grafted acrylamide groups, b) grafted acrylic acid groups or a salt or a substituted or unsubstituted (C₁-C₁₀)hydrocarbyl ester thereof, and c) a combination thereof. In some embodiments, the composition can be a hydraulic fracturing fluid.

The placing of the composition in the subterranean formation can include contacting the composition and any suitable part of the subterranean formation, or contacting the composition and a subterranean material, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include at least partially depositing the composition in a fracture, flow pathway, or area surrounding the same.

In some embodiments, the method includes obtaining or providing the composition including the cellulose or cellulose derivative having grafted groups thereon. The obtaining or providing of the composition can occur at any suitable time and at any suitable location. The obtaining or providing of the composition can occur above the surface (e.g., the cellulose or cellulose derivative can be mixed with other components of the composition above the surface). The obtaining or providing of the composition can occur in the subterranean formation (e.g., downhole, for example, the cellulose or cellulose derivative can be mixed with other components of the composition downhole).

The method can include hydraulic fracturing. For example, the method can be a method of hydraulic fracturing using the composition to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed in or contacted to, or the composition is placed in or contacted to an area surrounding the generated fracture or flow pathway.

In some embodiments, the method can be a method of drilling, stimulation, fracturing, spotting, clean-up, completion, remedial treatment, applying a pill, acidizing, cementing, packing, spotting, or a combination thereof.

The composition can include any suitable carrier fluid, in any suitable proportion. As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product or fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water (e.g., the composition can be an aqueous composition), brine, produced water, flowback water, brackish water, and sea water. The fluid can form about 0.001 wt % to about 99.999 wt % of a composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more. The composition can be an aqueous composition with the majority of the fluid phase thereof being water.

In various embodiments, the present invention provides a method of treating a subterranean formation. The method includes placing in the subterranean formation a composition including a cellulose or cellulose derivative, the cellulose or cellulose derivative including grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

In various embodiments, the present invention provides a method of treating a subterranean formation. The method includes placing in the subterranean formation a composition including a cellulose or cellulose derivative including repeating units having the structure:

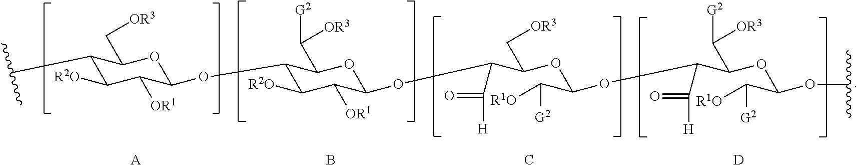

Repeating group A is present in the cellulose or cellulose derivative in A mol %. Repeating group B is present in the cellulose or cellulose derivative in B mol %. Repeating group C is present in the cellulose or cellulose derivative in C mol %. Repeating group D is present in the cellulose or cellulose derivative in D mol %. Repeating groups A, B, C, and D are in random or block copolymer arrangement. The variables A mol %, B mol %, C mol %, and D mol % are each independently about 0 mol % to about 99.999 mol %. At least one of B mol %, C mol %, and D mol % is greater than 0 mol %. The variables R¹, R², and R³ are each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted. At each occurrence, G¹ and G² each independently include a unit having the structure:

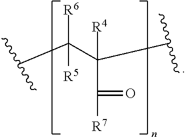

At each occurrence, the unit in G¹ or G² independently occurs in the direction shown or in the opposite direction. At each occurrence, R⁴, R⁵, R⁶ are independently chosen from —H and substituted or unsubstituted (C₁-C₁₀)hydrocarbyl. At each occurrence, R⁷ is independently chosen from substituted or unsubstituted —NH₂, —OH or a salt or (C₁-C₁₀)hydrocarbyl ester thereof. At each occurrence n is independently about 1 to about 100,000.

In various embodiments, the present invention provides a method of treating a subterranean formation. The method includes placing in the subterranean formation a composition including a cellulose or cellulose derivative having the structure:

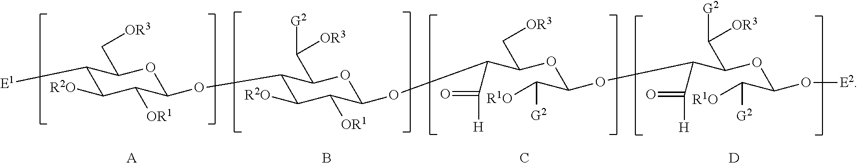

Repeating group A is present in the cellulose or cellulose derivative in A mol %. Repeating group B is present in the cellulose or cellulose derivative in B mol %. Repeating group C is present in the cellulose or cellulose derivative in C mol %. Repeating group D is present in the cellulose or cellulose derivative in D mol %. Repeating groups A, B, C, and D are in random or block copolymer arrangement. The variables A mol %, B mol %, C mol %, and D mol % are each independently about 0 mol % to about 99.999 mol %. At least one of B mol %, C mol %, and D mol % is greater than 0 mol %. At each occurrence, G¹ and G² each independently include a unit having the structure:

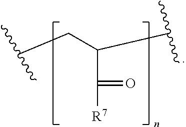

At each occurrence, the unit in G¹ or G² independently occurs in the direction shown or in the opposite direction. At each occurrence, R is independently chosen from substituted or unsubstituted —NH₂, —OH or a salt or (C₁-C₁₀)hydrocarbyl ester thereof. At each occurrence n is independently about 1 to about 100,000. The variable E¹ has the structure:

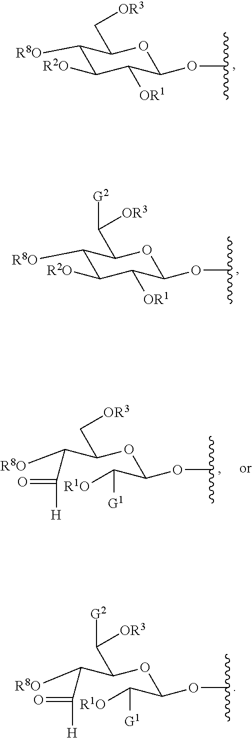

The variable E has the structure:

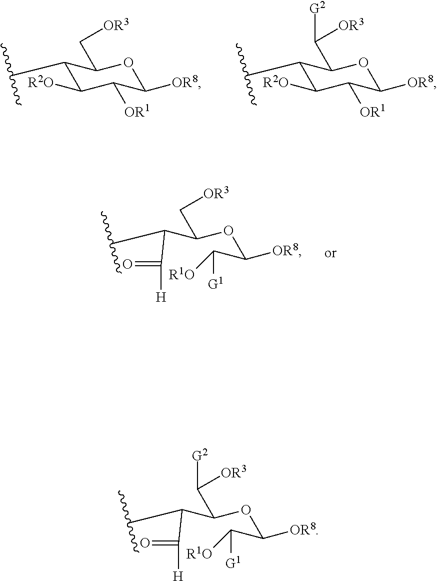

At each occurrence, R, R², R³, and R⁸ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

In various embodiments, the present invention provides a system. The system includes a composition including a cellulose or cellulose derivative, the cellulose or cellulose derivative including grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof. The system also includes a subterranean formation including the composition therein.

In various embodiments, the present invention provides a composition for treatment of a subterranean formation. The composition includes a cellulose or cellulose derivative including repeating units having the structure:

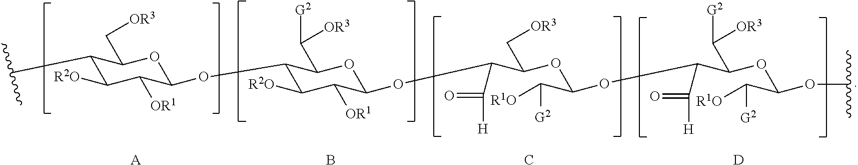

Repeating group A is present in the cellulose or cellulose derivative in A mol %. Repeating group B is present in the cellulose or cellulose derivative in B mol %. Repeating group C is present in the cellulose or cellulose derivative in C mol %. Repeating group D is present in the cellulose or cellulose derivative in D mol %. Repeating groups A, B, C, and D are in random or block copolymer arrangement. The variables A mol %, B mol %, C mol %, and D mol % are each independently about 0 mol % to about 99.999 mol %. At least one of B mol %, C mol %, and D mol % is greater than 0 mol %. The variables R, R², and R³ are each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted. At each occurrence, G¹ and G² each independently include a unit having the structure:

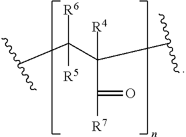

At each occurrence, the unit in G¹ or G² independently occurs in the direction shown or in the opposite direction. At each occurrence, R⁴, R⁵, R⁶ are independently chosen from —H and substituted or unsubstituted (C₁-C₁₀)hydrocarbyl. At each occurrence, R⁷ is independently chosen from substituted or unsubstituted —NH₂, —OH or a salt or (C₁-C₁₀)hydrocarbyl ester thereof. At each occurrence n is independently about 1 to about 100,000.

In various embodiments, the present invention provides a composition for treatment of a subterranean formation. The composition includes a cellulose or cellulose derivative having the structure:

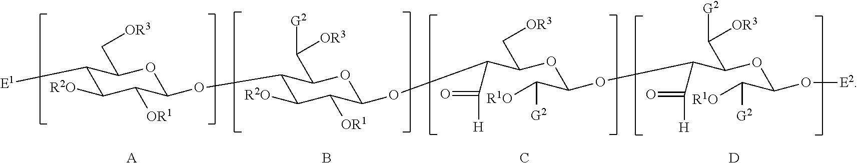

Repeating group A is present in the cellulose or cellulose derivative in A mol %. Repeating group B is present in the cellulose or cellulose derivative in B mol %. Repeating group C is present in the cellulose or cellulose derivative in C mol %. Repeating group D is present in the cellulose or cellulose derivative in D mol %. Repeating groups A, B, C, and D are in random or block copolymer arrangement. The variables A mol %, B mol %, C mol %, and D mol % are each independently about 0 mol % to about 99.999 mol %. At least one of B mol %, C mol %, and D mol % is greater than 0 mol %. At each occurrence, G¹ and G² each independently include a unit having the structure:

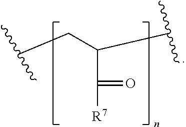

At each occurrence, the unit in G¹ or G² independently occurs in the direction shown or in the opposite direction. At each occurrence, R⁷ is independently chosen from substituted or unsubstituted —NH₂, —OH or a salt or (C₁-C₁₀)hydrocarbyl ester thereof. At each occurrence n is independently about 1 to about 100,000. The variable E¹ has the structure:

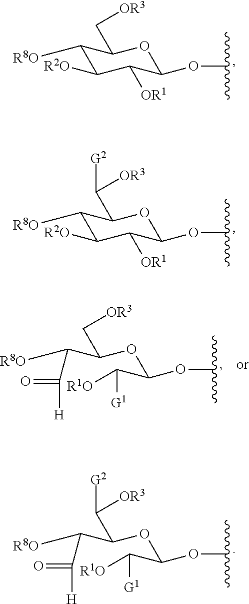

The variable E² has the structure:

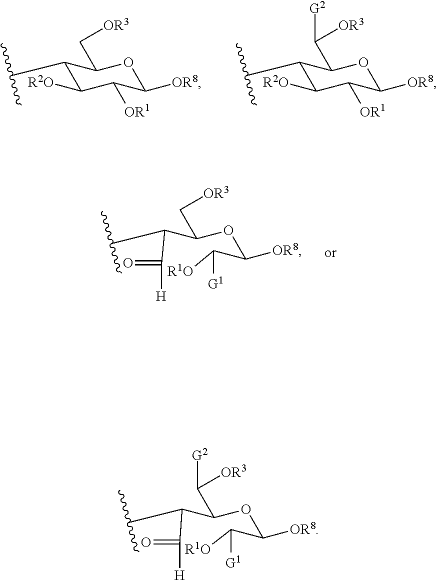

At each occurrence, R¹, R², R³, and R⁸ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

In various embodiments, the present invention provides a method of preparing a composition for treatment of a subterranean formation. The method includes forming a composition including a cellulose or cellulose derivative, the cellulose or cellulose derivative including grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

In various embodiments, the composition including the cellulose or cellulose derivative including grafted acrylamide or acrylic acid groups and method of using the same can provide advantages over other compositions for subterranean treatment, at least some of which are unexpected. In various embodiments, the composition including the cellulose or cellulose derivative including grafted acrylamide or acrylic acid groups can provide fewer or no residues, such as fewer or no insoluble residues, which can provide less pore-clogging and better production rates with less clean-up time and effort than other fracturing fluids. In various embodiments, the composition including the cellulose or cellulose derivative including grafted acrylamide or acrylic acid groups can have less friction while being pumped into the subterranean formation than other fracturing fluids. In various embodiments, the combination of reduced friction and lower amounts of residue provided by the composition can provide more efficient fracturing with less energy expenditure to pump and less time and energy spent on clean up as compared to polysaccharide-based fracturing fluids such as guar-based fluids. In various embodiments, the composition including the cellulose or cellulose derivative including grafted acrylamide or acrylic acid groups can provide a tunable polymer system wherein modification of the structure of the grafted group, a change in the type of cellulose derivative used, or an adjustment of the concentration of the grafted cellulose or cellulose derivative can provide a desired amount of friction reduction.

In various embodiments, the composition including the cellulose or cellulose derivative including grafted acrylamide or acrylic acid groups can have low enough friction that it is more suitable for use in higher rate hybrid jobs, such as in unconventional reservoirs, as compared to other low residue fluids that are alternatives to guar or derivatized guar systems. In various embodiments, the composition including the cellulose or cellulose derivative including grafted acrylamide or acrylic acid groups can reduce gelling agent loading by increasing polymer chain entanglement (e.g., reduce critical polymer concentration). In various embodiments, the composition including the cellulose or cellulose derivative including grafted acrylamide or acrylic acid groups can improve clean up due to reduced gelling agent loading. In various embodiments, replacing or supplementing a synthetic friction reducer with the cellulose or cellulose derivative including grafted acrylamide or acrylic acid groups can provide a cleaner and more residue-free friction reducing system. In various embodiments, the composition including the cellulose or cellulose derivative including grafted acrylamide or acrylic acid groups can be used as a slickwater that is cleaner and more residue-free than other slickwaters.

### Cellulose or Cellulose Derivative Including Grafted Groups.

The composition includes a cellulose or cellulose derivative including grafted groups. The composition can include one cellulose or cellulose derivative including grafted groups, or more than one cellulose or cellulose derivative including grafted groups. Any suitable proportion of the composition can be the one or more cellulose derivatives including grafted groups, such as about 0.01 wt % to about 50 wt %, about 0.1 wt % to about 20 wt %, or about 0.01 wt % or less, or about 0.1 wt %, 1, 2, 3, 4, 5, 6, 8, 10, 12, 14, 16, 18, 20, 25, 30, 35, 40, 45, or about 50 wt % or more. In addition to the cellulose or cellulose derivative including grafted groups, the composition can optionally include a cellulose or cellulose derivative not including grafted groups (e.g., free of grafted groups thereon).

The cellulose or cellulose derivative including the grafted groups can be any suitable cellulose or cellulose derivative. For example, the cellulose or cellulose derivative can be at least one of a hydroxy(C₁-C₁₀)alkyl cellulose (e.g., from cellulose via epoxides, with examples including hydroxyethyl cellulose, hydroxypropyl cellulose, hydroxyethyl methyl cellulose, hydroxypropyl methyl cellulose, and ethyl hydroxyethyl cellulose), a carboxy(C₁-C₁₀)alkyl cellulose or a salt or substituted or unsubstituted (C₁-C₁₀)hydrocarbyl ester thereof (e.g., from cellulose via halogenated carboxylic acids, with examples including carboxymethyl cellulose, hydroxyethyl carboxymethyl cellulose, carboxymethyl cellulose sodium salt, and hydroxyethyl carboxymethyl cellulose sodium salt), a (C₁-C₁₀)alkyl cellulose (e.g., from cellulose via halogenoalkanes, with examples including methyl cellulose, ethyl cellulose, and ethyl methyl cellulose), and an organic or inorganic ester derivative (e.g., from cellulose via organic or inorganic acids, with examples including cellulose acetate, cellulose diacetate, cellulose triacetate, cellulose propionate, cellulose acetate propionate, cellulose acetate butyrate, cellulose acrylate, cellulose methacrylate, nitrocellulose, and cellulose sulfate), wherein each (C₁-C₁₀)alkyl group is independently selected and is substituted or unsubstituted.

The cellulose or cellulose derivative including the grafted groups can be prepared via any suitable method, such as conventional free radical polymerization, or a controlled polymerization method (e.g., atom-transfer radical polymerization (ATRP), reversible addition-fragmentation chain-transfer polymerization (RAFT), and the like). In some embodiments, the cellulose or cellulose derivative can be prepared via a method including treating a cellulose or cellulose derivative with at least one of a redox initiator (e.g., treatment with a ceric(IV) ion, such as via ceric ammonium nitrate (CAN) or ceric ammonium sulfate (CAS); iron(II)-hydrogen peroxide (Fenton reagent); a Co(III) acetylacetonate complex salt; Co(II)-potassium monopersulfate; and sodium sulfite-ammonium persulfate), a free radical initiator (e.g., azobisisobutyronitrile (AIBN), potassium persulfate, and ammonium persulfate), radiation (e.g., alpha, beta, or gamma radiation), and microwave irradiation. In some embodiments, redox initiators can be used at low temperature and can selectively react with the amorphous region of a cellulose without reacting with or with only slight reaction with the crystalline phase. In some embodiments, the cellulose or cellulose derivative is treated with a ceric(IV) ion. In some embodiments, the cellulose or cellulose derivative is treated with at least one of ceric ammonium nitrate and ceric ammonium sulfate.

In various embodiments, the cellulose or cellulose derivative including the grafted groups can include a repeating unit having the structure:

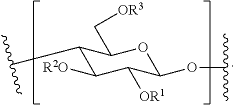

At each occurrence, R¹, R², and R³ can be each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted. The variables R¹, R², and R³ can each be independently chosen from —H, (C₁-C₆)hydrocarbyl, —(C₁-C₆)hydrocarbyl-OH, —C(O)—(C₁-C₆)hydrocarbyl, —(C₁-C₆)hydrocarbylene-C(O)OH or a salt or a (C₁-C₆)hydrocarbyl ester thereof, —NO₂, —S(O)₂—OH or a salt or a (C₁-C₆)hydrocarbyl ester thereof, wherein each (C₁-C₆)hydrocarbyl and (C₁-C₆)hydrocarbylene is independently selected and is unsubstituted. The variables R¹, R², and R³ can each be independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)hydrocarbyl and (C₁-C₃)hydrocarbylene is independently selected. The variables R, R², and R³ can each be —H.

The cellulose or cellulose derivative including the grafted groups can include a repeating unit having the structure:

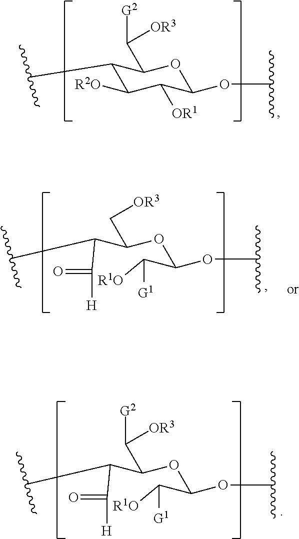

At each occurrence, G¹ and G² can each independently include a unit having the structure:

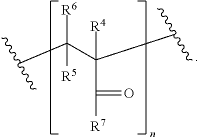

At each occurrence, the unit in G¹ or G² independently occurs in the direction shown or in the opposite direction. At each occurrence n can be independently about 1 to about 100,000, such as about 1 (e.g., the unit can be a non-repeating unit), 2 (e.g., the unit can be a repeating unit), 3, 4, 5, 6, 7, 8, 9, 10, 12, 14, 16, 18, 20, 25, 30, 35, 40, 45, 50, 75, 100, 150, 200, 250, 500, 750, 1,000, 1,500, 2,000, 2,500, 5,000, 10,000, 15,000, 20,000, 25,000, 50,000, 75,000, or about 100,000 or more. The groups G¹ and G² can terminate in any suitable way. In some examples, G¹ and G² can terminate with an —H.

At each occurrence, R⁴, R⁵, R⁶ can each be independently chosen from —H and substituted or unsubstituted (C₁-C₁₀)hydrocarbyl, wherein each (C₁-C₁₀)hydrocarbyl is independently selected. At each occurrence, R⁴, R⁵, R⁶ can be independently chosen from —H and (C₁-C₆)hydrocarbyl. At each occurrence, R⁴, R⁵, R⁶ can be independently chosen from —H and (C₁-C₃)alkyl. At each occurrence, R⁴, R⁵, R⁶ can be —H.

At each occurrence, R⁷ can be independently chosen from substituted or unsubstituted —NH₂, —OH or a salt or (C₁-C₁₀)hydrocarbyl ester thereof, wherein each (C₁-C₁₀)hydrocarbyl is independently selected. At each occurrence, R can be independently chosen from —NH₂, —OH or a salt thereof. At each occurrence, R⁷ can be —NH₂. In some embodiments, R⁷ can be either —NH₂ or —OH or a salt or ester thereof (e.g., a salt of the —OH group, or an ester of the —OH group), with about 0.01 mol % or less of R⁷ being —NH₂, or about 0.01 mol % to about 100 mol %, or about 25 mol % to about 100 mol %, about 50 mol % to about 100 mol %, about 75 mol % to about 100 mol %, or about 0.1 mol %, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 92, 94, 96, 98, 99, 99.9 mol %, or about 99.99 mol % or more, with the remainder being —OH or a salt or ester thereof.

At each occurrence, G¹ and G² can each independently have the structure:

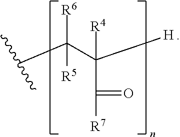

At each occurrence the unit can occur in the direction shown or in the opposite direction.

The cellulose or cellulose derivative including the grafted groups can include a repeating unit having the structure:

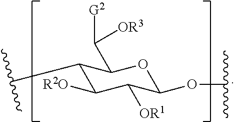

The cellulose or cellulose derivative including the grafted groups can include a repeating unit having the structure:

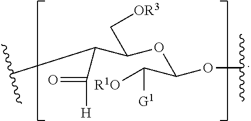

The cellulose or cellulose derivative including the grafted groups can include a repeating unit having the structure:

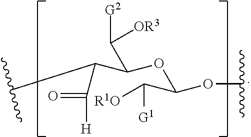

The cellulose or cellulose derivative including the grafted groups can include repeating units having the structure:

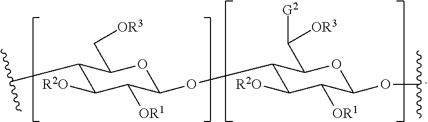

The repeating units can be in a block or random arrangement.

The cellulose or cellulose derivative including the grafted groups can include repeating units having the structure:

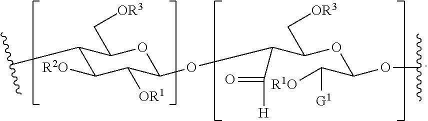

The repeating units can be in a block or random arrangement.

The cellulose or cellulose derivative including the grafted groups can include repeating units having the structure:

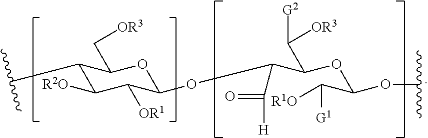

The repeating units can be in a block or random arrangement.

The cellulose or cellulose derivative including the grafted groups can have the structure:

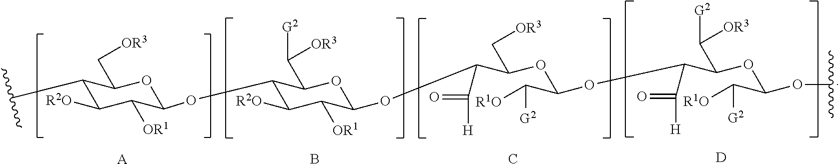

Repeating group A can be present in the cellulose or cellulose derivative in A mol % (e.g., about 0 mol % to about 99.999 mol %, or about 0 mol %, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 mol % or more). Repeating group B can be present in the cellulose or cellulose derivative in B mol % (e.g., about 0 mol % to about 100 mol %, or about 0 mol %, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, 99.999 mol % or more, or about 100 mol %). Repeating group C can be present in the cellulose or cellulose derivative in C mol % (e.g., about 0 mol % to about 100 mol %, or about 0 mol %, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, 99.999 mol % or more, or about 100 mol %). Repeating group D can be present in the cellulose or cellulose derivative in D mol % (e.g., about 0 mol % to about 100 mol %, or about 0 mol %, 1, 2, 3, 4, 5, 6, 7, 8, 9, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, 99.999 mol % or more, or about 100 mol %). Repeating groups A, B, C, and D can be in random or block copolymer arrangement. The variables A mol %, B mol %, C mol %, and D mol % can be each independently about 0 mol % to about 99.999 mol %. At least one of B mol %, C mol %, and D mol % can be greater than 0 mol %.

The cellulose or cellulose derivative including the grafted groups can terminate in any suitable way. In some embodiments, the cellulose or cellulose derivative including in the groups E¹- and -E². The variable E¹ can have the structure:

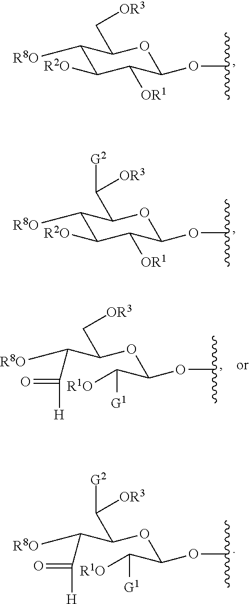

The variable E² can have the structure:

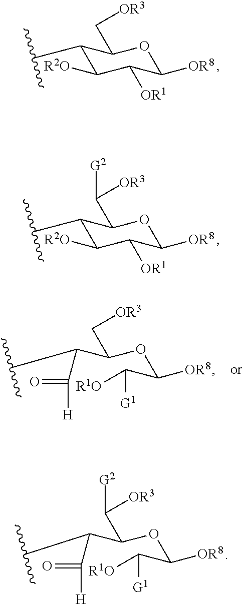

At each occurrence R⁸ can be independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted. At each occurrence R⁸ can be independently chosen from —H, (C₁-C₆)hydrocarbyl, —(C₁-C₆)hydrocarbyl-OH, —C(O)—(C₁-C₆)hydrocarbyl, —(C₁-C₆)hydrocarbylene-C(O)OH or a salt or a (C₁-C₆)hydrocarbyl ester thereof, —NO₂, —S(O)₂—OH or a salt or a (C₁-C₆)hydrocarbyl ester thereof, wherein each (C₁-C₆)hydrocarbyl and (C₁-C₆)hydrocarbylene is independently selected and is unsubstituted. At each occurrence R⁸ can be independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl and (C₁-C₃)alkylene is independently selected. The variable R⁸ can be —H.

The cellulose or cellulose derivative including the grafted groups can have the structure:

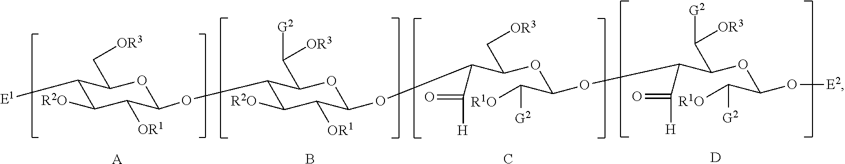

Repeating group A can be present in the cellulose or cellulose derivative in A mol %. Repeating group B can be present in the cellulose or cellulose derivative in B mol %. Repeating group C can be present in the cellulose or cellulose derivative in C mol %. Repeating group D can be present in the cellulose or cellulose derivative in D mol %. Repeating groups A, B, C, and D can be in random or block copolymer arrangement. The variables A mol %, B mol %, C mol %, and D mol % can be each independently about 0 mol % to about 99.999 mol %. At least one of B mol %, C mol %, and D mol % can be greater than 0 mol %.

### Other Components.

The composition including the cellulose or cellulose derivative including grafted groups, or a mixture including the composition, can include any suitable additional component in any suitable proportion, such that the cellulose or cellulose derivative including grafted groups, composition, or mixture including the same, can be used as described herein. Any component listed in this section can be present or not present in the composition or a mixture including the same.

In some embodiments, the composition or a mixture including the same includes one or more friction reducers (in addition to the cellulose or cellulose derivative having grafted groups thereon). The friction reducer can be any suitable friction reducer. The friction reducer can be at least one of an acrylamide polymer or an acrylamide copolymer. The friction reducer can be a polymer or copolymer including repeating groups of at least one of acrylamide, methylacrylamide, N,N-dimethylacrylamide, and 2-acrylamido-2-methylpropane sulfonic acid (AMPS) or a salt or ester thereof. The friction reducer can be an acrylamide The friction reducer can be a surfactant, such as any surfactant described herein. The friction reducer can be any proportion of the composition or a mixture including the same, such as about 0.001 wt % to about 50 wt %, about 0.001 wt % to about 30 wt %, about 0.01 wt % to about 5 wt %, about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

In some embodiments, the composition or a mixture including the same includes a surfactant, such as any suitable surfactant, such as an anionic surfactant, a cationic surfactant, a zwitterionic surfactant, or a nonionic surfactant. The surfactant can form any suitable proportion of the composition or mixture including the same, such as 0.01 wt % to about 50 wt %, or about 0.1 wt % to about 20 wt %, or about 0.01 wt % or less, or about 0.1 wt %, 1, 2, 3, 4, 5, 6, 8, 10, 12, 14, 16, 18, 20, 25, 30, 35, 40, 45 wt %, or about 50 wt % or more.

In some embodiments, the surfactant can be amine-functional, such as an amine ethoxylate or an amine ethoxylated quaternary salt, such as tallow diamine and tallow triamine exthoxylates and quaternary salts. The surfactant can be can be an ethoxylated C₁₂-C₂₂ diamine, an ethoxylated C₁₂-C₂₂ triamine, ethoxylated C₁₂-C₂₂ tetraamine, ethoxylated C₁₂-C₂₂ diamine methylchloride quaternary salt, ethoxylated C₁₂-C₂₂ triamine methylchloride quaternary salt, ethoxylated C₁₂-C₂₂ tetraamine methylchloride quaternary salt, ethoxylated C₁₂-C₂₂ diamine reacted with sodium chloroacetate, ethoxylated C₁₂-C₂₂ triamine reacted with sodium chloroacetate, ethoxylated C₁₂-C₂₂ tetraamine reacted with sodium chloroacetate, ethoxylated C₁₂-C₂₂ diamine acetate salt, ethoxylated C₁₂-C₂₂ diamine hydrochloric acid salt, ethoxylated C₁₂-C₂₂ diamine glycolic acid salt, ethoxylated C₁₂-C₂₂ diamine dodecylbenzenesulfonic acid (DDBSA) salt, ethoxylated C₁₂-C₂₂ triamine acetate salt, ethoxylated C₁₂-C₂₂ triamine hydrochloric acid salt, ethoxylated C₁₂-C₂₂ triamine glycolic acid salt, ethoxylated C₁₂-C₂₂ triamine DDBSA salt, ethoxylated C₁₂-C₂₂ tetraamine acetate salt, ethoxylated C₁₂-C₂₂ tetraamine hydrochloric acid salt, ethoxylated C₁₂-C₂₂ tetraamine glycolic acid salt, ethoxylated C₁₂-C₂₂ tetraamine DDBSA salt, pentamethylated C₁₂-C₂₂ diamine quaternary salt, heptamethylated C₁₂-C₂₂ diamine quaternary salt, nonamethylated C₁₂-C₂₂ diamine quaternary salt, and combinations thereof.

The surfactant can have the structure:

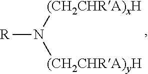

wherein R is a C₁₂-C₂₂ aliphatic hydrocarbon; R′ is independently selected from hydrogen or C₁-C₃ alkyl group; A is NH or O, and x+y has a value greater than or equal to one but also less than or equal to three. The R group can be a non-cyclic aliphatic. In some embodiments, the R group contains at least one degree of unsaturation (e.g., at least one carbon-carbon double bond). In other embodiments, the R group can be a commercially recognized mixture of aliphatic hydrocarbons such as soya, which is a mixture of C₁₄-C₂₀ hydrocarbons; tallow, which is a mixture of C₁₆-C₂₀, aliphatic hydrocarbons; or tall oil, which is a mixture of C₁₄-C₁₈ aliphatic hydrocarbons. In some embodiments, the A group is NH, and the value of x+y is two; in some examples, x is one. In some embodiments, the A group is 0, and the value of x+y is two; in some examples, x is one. Examples of commercially available amine surfactants are TER 2168 Series™ available from Champion Chemicals located in Fresno, Tex.; Ethomeen® T/12, a diethoxylated tallow amine; Ethomeen® S/12, a diethoxylated soya amine; Duomeen®0, a N-oleyl-1,3-diaminopropane; and Duomeen® T, an N-tallow-1,3-diaminopropane, all of which are available from Akzo Nobel.

In some embodiments, the surfactant can be a tertiary alkyl amine ethoxylate (a cationic surfactant). Triton® RW-100 surfactant (e.g., x and y=10 moles of ethylene oxide) and Triton® RW-150 surfactant (x and y=15 moles of ethylene oxide) are examples of tertiary alkyl amine ethoxylates that can be purchased from Dow Chemical Company.

In some embodiments, the surfactant can be used as a combination of an amphoteric surfactant and an anionic or cationic surfactant. The amphoteric surfactant can be lauryl amine oxide, a mixture of lauryl amine oxide and myristyl amine oxide (e.g., a lauryl/myristyl amine oxide), cocoamine oxide, lauryl betaine, oleyl betaine, or combinations thereof. The cationic surfactant can be cocoalkyltriethyl ammonium chloride, hexadecyltrimethyl ammonium chloride, or combinations thereof (e.g., 50:50 mixture by weight of cocoalkyltriethylammonium chloride and the hexadecyltrimethyl ammonium chloride).

In some embodiments, the surfactant is a nonionic surfactant, such as an alcohol oxylalkylate, an alkyl phenol oxylalkylates, a nonionic ester such as a sorbitan esters and an alkoxylates of a sorbitan ester. Examples of nonionic surfactants include castor oil alkoxylates, fatty acid alkoxylates, lauryl alcohol alkoxylates, nonylphenol alkoxylates, octylphenol alkoxylates, tridecyl alcohol alkoxylates, POE-10 nonylphenol ethoxylate, POE-100 nonylphenol ethoxylate, POE-12 nonylphenol ethoxylate, POE-12 octylphenol ethoxylate, POE-12 tridecyl alcohol ethoxylate, POE-14 nonylphenol ethoxylate, POE-15 nonylphenol ethoxylate, POE-18 tridecyl alcohol ethoxylate, POE-20 nonylphenol ethoxylate, POE-20 oleyl alcohol ethoxylate, POE-20 stearic acid ethoxylate, POE-3 tridecyl alcohol ethoxylate, POE-30 nonylphenol ethoxylate, POE-30 octylphenol ethoxylate, POE-34 nonylphenol ethoxylate, POE-4 nonylphenol ethoxylate, POE-40 castor oil ethoxylate, POE-40 nonylphenol ethoxylate, POE-40 octylphenol ethoxylate, POE-50 nonylphenol ethoxylate, POE-50 tridecyl alcohol ethoxylate, POE-6 nonylphenol ethoxylate, POE-6 tridecyl alcohol ethoxylate, POE-8 nonylphenol ethoxylate, POE-9 octylphenol ethoxylate, mannide monooleate, sorbitan isostearate, sorbitan laurate, sorbitan monoisostearate, sorbitan monolaurate, sorbitan monooleate, sorbitan monopalmitate, sorbitan monostearate, sorbitan oleate, sorbitan palmitate, sorbitan sesquioleate, sorbitan stearate, sorbitan trioleate, sorbitan tristearate, POE-20 sorbitan monoisostearate ethoxylate, POE-20 sorbitan monolaurate ethoxylate, POE-20 sorbitan monooleate ethoxylate, POE-20 sorbitan monopalmitate ethoxylate, POE-20 sorbitan monostearate ethoxylate, POE-20 sorbitan trioleate ethoxylate, POE-20 sorbitantristearate ethoxylate, POE-30 sorbitan tetraoleate ethoxylate, POE-40 sorbitan tetraoleate ethoxylate, POE-6 sorbitan hexastearate ethoxylate, POE-6 sorbitan monstearate ethoxylate, POE-6 sorbitan tetraoleate ethoxylate, and/or POE-60 sorbitan tetrastearate ethoxylate, POE-23 lauryl alcohol, POE-20 nonylphenyl ether. Other applicable nonionic surfactants are esters such as sorbitan monooleate.

Surfactants can act as emulsion stabilizers. In some examples, an emulsifying surfactant is ionic to give charge stabilization or has long groups for steric stability in water, such as cationic surfactants and anionic surfactants. Examples of emulsifying surfactants can be hexahydro-1,3,5-tris(2-hydroxyethyl)triazine, alkyl ether phosphate, ammonium lauryl sulfate, ammonium nonylphenol ethoxylate sulfate, branched isopropyl amine dodecylbenzene sulfonate, branched sodium dodecylbenzene sulfonate, dodecylbenzene sulfonic acid, branched dodecylbenzene sulfonic acid, fatty acid sulfonate potassium salt, phosphate esters, POE-1 ammonium lauryl ether sulfate, POE-1 sodium lauryl ether sulfate, POE-10 nonylphenol ethoxylate phosphate ester, POE-12 ammonium lauryl ether sulfate, POE-12 linear phosphate ester, POE-12 sodium lauryl ether sulfate, POE-12 tridecyl alcohol phosphate ester, POE-2 ammonium lauryl ether sulfate, POE-2 sodium lauryl ether sulfate, POE-3 ammonium lauryl ether sulfate, POE-3 disodium alkyl ether sulfosuccinate, POE-3 linear phosphate ester, POE-3 sodium lauryl ether sulfate, POE-3 sodium octylphenol ethoxylate sulfate, POE-3 sodium tridecyl ether sulfate, POE-3 tridecyl alcohol phosphate ester, POE-30 ammonium lauryl ether sulfate, POE-30 sodium lauryl ether sulfate, POE-4 ammonium lauryl ether sulfate, POE-4 ammonium nonylphenol ethoxylate sulfate, POE-4 nonyl phenol ether sulfate, POE-4 nonylphenol ethoxylate phosphate ester, POE-4 sodium lauryl ether sulfate, POE-4 sodium nonylphenol ethoxylate sulfate, POE-4 sodium tridecyl ether sulfate, POE-50 sodium lauryl ether sulfate, POE-6 disodium alkyl ether sulfosuccinate, POE-6 nonylphenol ethoxylate phosphate ester, POE-6 tridecyl alcohol phosphate ester, POE-7 linear phosphate ester, POE-8 nonylphenol ethoxylate phosphate ester, potassium dodecyl benzene sulfonate, sodium 2-ethyl hexyl sulfate, sodium alkyl ether sulfate, sodium alkyl sulfate, sodium alpha olefin sulfonate, sodium decyl sulfate, sodium dodecylbenzene sulfonate, sodium lauryl sulfate, sodium lauryl sulfoacetate, sodium nonylphenol ethoxylate sulfate, and sodium octyl sulfate.

In some embodiments, the composition or a mixture including the same includes a carbohydrate used commonly for slick water applications, such as at least one of cellulose, a cellulose derivative (e.g., hydroxyethyl cellulose (HEC), carboxymethyl hydroxyethyl cellulose (CMHEC), carboxymethyl cellulose (CMC), dialkyl carboxymethyl cellulose), starch, a starch derivative, xanthan, a xanthan derivative, guar, and guar gum derivative, locust bean gum, karaya gum, xanthan gum, scleroglucan, and diutan. The one or more carbohydrates can be any proportion of the composition or a mixture including the same, such as about 0.001 wt % to about 50 wt %, about 0.001 wt % to about 30 wt %, about 0.01 wt % to about 5 wt %, about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

In some embodiments, the composition or a mixture including the same includes one or more viscosifiers. The viscosifier can be any suitable viscosifier. The viscosifier can affect the viscosity of the composition or a solvent that contacts the composition at any suitable time and location. In some embodiments, the viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the viscosifier can be about 0.000.1 wt % to about 10 wt % of the composition or a mixture including the same, about 0.004 wt % to about 0.01 wt %, or about 0.000.1 wt % or less, 0.000.5 wt %, 0.001, 0.005, 0.01, 0.05, 0.1, 0.5, 1, 2, 3, 4, 5, 6, 7, 8, 9, or about 10 wt % or more of the composition or a mixture including the same.

The viscosifier can include at least one of a substituted or unsubstituted polysaccharide, and a substituted or unsubstituted polyalkene (e.g., a polyethylene, wherein the ethylene unit is substituted or unsubstituted, derived from the corresponding substituted or unsubstituted ethene), wherein the polysaccharide or polyalkene is crosslinked or uncrosslinked. The viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and a poly((C₂-C₁₀)alkene), wherein the (C₂-C₁₀)alkene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, karaya gum, cellulose (e.g., not having grafted groups thereon), and derivatized cellulose (e.g., not having grafted groups thereon, such as carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition or a mixture including the same can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). In some embodiments, the crosslinker can crosslink the cellulose or cellulose derivative having grafted groups thereon, and can alternatively or additionally crosslink other materials in the composition, such as a viscosifier polymer. The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.000.01 wt % to about 5 wt % of the composition or a mixture including the same, about 0.001 wt % to about 0.01 wt %, or about 0.000.01 wt % or less, or about 0.000.05 wt %, 0.000,1, 0.000,5, 0.001, 0.005, 0.01, 0.05, 0.1, 0.5, 1, 2, 3, 4, or about 5 wt % or more.

In some embodiments, the composition or a mixture including the same can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release of the breaker, such that the surrounding liquid can remain viscous for a suitable amount of time prior to breaking. The breaker can be any suitable breaker; for example, the breaker can be a compound that includes at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hypochlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition or a mixture including the same, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the cellulose or cellulose derivative including grafted groups or a mixture including the same can include any suitable downhole fluid. The composition including the cellulose or cellulose derivative including grafted groups can be combined with any suitable downhole fluid before, during, or after the placement of the composition in the subterranean formation or the contacting of the composition and the subterranean material. In some examples, the composition including the cellulose or cellulose derivative including grafted groups is combined with a downhole fluid above the surface, and then the combined composition is placed in a subterranean formation or contacted with a subterranean material. In another example, the composition including the cellulose or cellulose derivative including grafted groups is injected into a subterranean formation to combine with a downhole fluid, and the combined composition is contacted with a subterranean material or is considered to be placed in the subterranean formation. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition, or a mixture including the same, can include any suitable amount of any suitable material used in a downhole fluid. For example, the composition or a mixture including the same can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, oil-wetting agents, set retarding additives, surfactants, gases, weight reducing additives, heavy-weight additives, lost circulation materials, filtration control additives, salts (e.g., any suitable salt, such as potassium salts such as potassium chloride, potassium bromide, potassium formate; calcium salts such as calcium chloride, calcium bromide, calcium formate; cesium salts such as cesium chloride, cesium bromide, cesium formate, or a combination thereof), fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, lime, or a combination thereof. In various embodiments, the composition or a mixture including the same can include one or more additive components such as: COLDTROL®, ATC®, OMC 2™, and OMC 42™ thinner additives; RHEMOD™ viscosifier and suspension agent; TEMPERUS™ and VIS-PLUS® additives for providing temporary increased viscosity; TAU-MOD™ viscosifying/suspension agent; ADAPTA®, DURATONE® HT, THERMO TONE™, BDF™-366, and BDF™-454 filtration control agents; LIQUITONE™ polymeric filtration agent and viscosifier; FACTANT™ emulsion stabilizer; LE SUPERMUL™, EZ MUL® NT, and FORTI-MUL® emulsifiers; DRIL TREAT® oil wetting agent for heavy fluids; AQUATONE-S™ wetting agent; BARACARB® bridging agent; BAROID® weighting agent; BAROLIFT® hole sweeping agent; SWEEP-WATE® sweep weighting agent; BDF-508 rheology modifier; and GELTONE® II organophilic clay. In various embodiments, the composition or a mixture including the same can include one or more additive components such as: X-TEND® II, PAC™-R, PAC™-L, LIQUI-VIS® EP, BRINEDRIL-VIS™, BARAZAN®, N-VIS®, and AQUAGEL® viscosifiers; THERMA-CHEK®, N-DRIL™ N-DRIL™ HT PLUS, IMPERMEX®, FILTERCHEK™, DEXTRID®, CARBONOX®, and BARANEX® filtration control agents; PERFORMATROL®, GEM™, EZ-MUD®, CLAY GRABBER®, CLAYSEAL®, CRYSTAL-DRIL®, and CLAY SYNC™ II shale stabilizers; NXS-LUBE™, EP MUDLUBE®, and DRIL-N-SLIDE™ lubricants; QUIK-THIN®, IRON-THIN™, THERMA-THIN®, and ENVIRO-THIN™ thinners; SOURSCAV™ scavenger; BARACOR® corrosion inhibitor; and WALL-NUT®, SWEEP-WATE®, STOPPIT™, PLUG-GIT®, BARACARB®, DUO-SQUEEZE®, BAROFIBRE™, STEELSEAL®, and HYDRO-PLUG® lost circulation management materials. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill bit as well as reduce friction between the drill string and the sides of the hole. The drilling fluid aids in support of the drill pipe and drill bit, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the composition or a mixture including the same in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, or about 99.999 wt % or more.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents or additives for suspension control, weight or density control, oil-wetting agents, fluid loss or filtration control agents, and rheology control agents. An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the cellulose or cellulose derivative including grafted groups can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, about 0 wt % to about 95 wt %, about 20 wt % to about 95 wt %, or about 50 wt % to about 90 wt %. A cement kiln dust can be present in an amount of at least about 0.01 wt %, or about 5 wt % to about 80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition or a mixture including the same. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ polytetrafluoroethylene), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### Drilling Assembly.

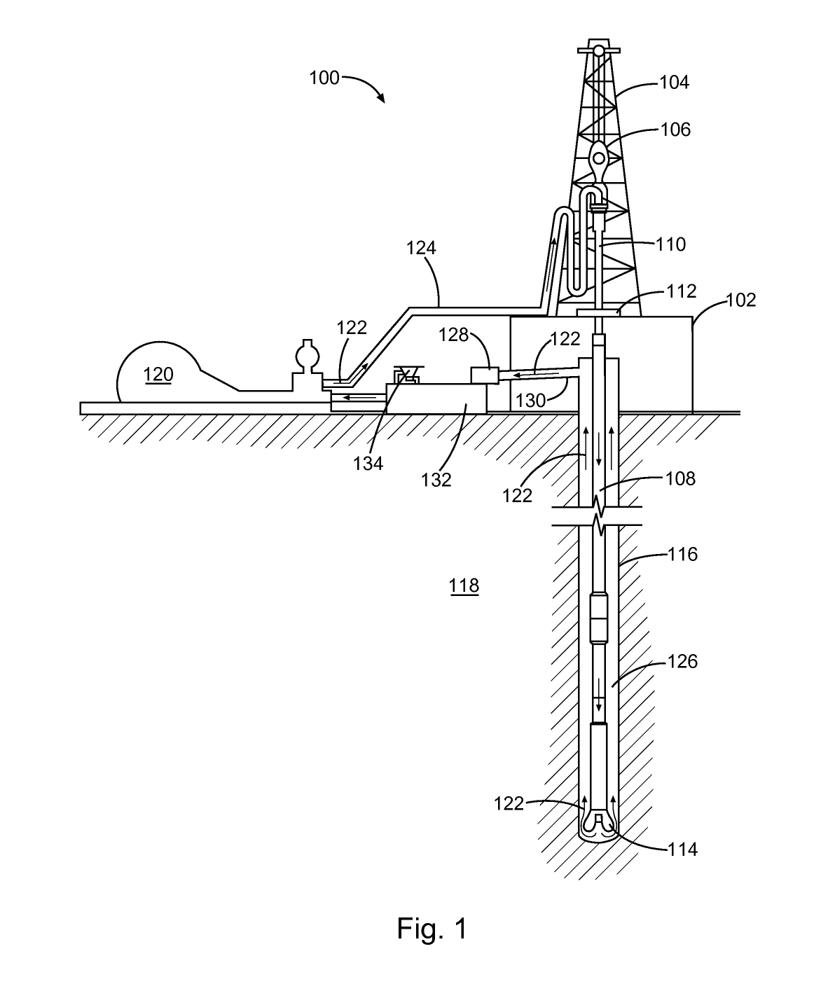

In various embodiments, the composition including the cellulose or cellulose derivative including grafted groups disclosed herein can directly or indirectly affect one or more components or pieces of equipment associated with the preparation, delivery, recapture, recycling, reuse, and/or disposal of the disclosed composition including the cellulose or cellulose derivative including grafted groups. For example, and with reference to FIG. 1, the disclosed composition including the cellulose or cellulose derivative including grafted groups can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While the fluid processing unit(s) 128 is illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the cellulose or cellulose derivative including grafted groups can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the cellulose or cellulose derivative including grafted groups can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the cellulose or cellulose derivative including grafted groups can be stored, reconditioned, and/or regulated until added to the drilling fluid 122.

As mentioned above, the composition including the cellulose or cellulose derivative including grafted groups can directly or indirectly affect the components and equipment of the drilling assembly 100. For example, the composition including the cellulose or cellulose derivative including grafted groups can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the cellulose or cellulose derivative including grafted groups.

The composition including the cellulose or cellulose derivative including grafted groups can directly or indirectly affect the pump 120, which representatively includes any conduits, pipelines, trucks, tubulars, and/or pipes used to fluidically convey the composition including the cellulose or cellulose derivative including grafted groups to the subterranean formation; any pumps, compressors, or motors (e.g., topside or downhole) used to drive the composition into motion; any valves or related joints used to regulate the pressure or flow rate of the composition; and any sensors (e.g., pressure, temperature, flow rate, and the like), gauges, and/or combinations thereof, and the like. The composition including the cellulose or cellulose derivative including grafted groups can also directly or indirectly affect the mixing hopper 134 and the retention pit 132 and their assorted variations.

The composition including the cellulose or cellulose derivative including grafted groups can also directly or indirectly affect the various downhole or subterranean equipment and tools that can come into contact with the composition including the cellulose or cellulose derivative including grafted groups such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the cellulose or cellulose derivative including grafted groups can also directly or indirectly affect any downhole heat exchangers, valves and corresponding actuation devices, tool seals, packers and other wellbore isolation devices or components, and the like associated with the wellbore 116. The composition including the cellulose or cellulose derivative including grafted groups can also directly or indirectly affect the drill bit 114, which can include roller cone bits, polycrystalline diamond compact (PDC) bits, natural diamond bits, hole openers, reamers, coring bits, and the like.

While not specifically illustrated herein, the composition including the cellulose or cellulose derivative including grafted groups can also directly or indirectly affect any transport or delivery equipment used to convey the composition including the cellulose or cellulose derivative including grafted groups to the drilling assembly 100 such as, for example, any transport vessels, conduits, pipelines, trucks, tubulars, and/or pipes used to fluidically move the composition including the cellulose or cellulose derivative including grafted groups from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include a composition including the cellulose or cellulose derivative including grafted groups. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), with the tubular containing a composition including the cellulose or cellulose derivative including grafted groups described herein.

In some embodiments, the system can include a drill string disposed in a wellbore, with the drill string including a drill bit at a downhole end of the drill string. The system can also include an annulus between the drill string and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

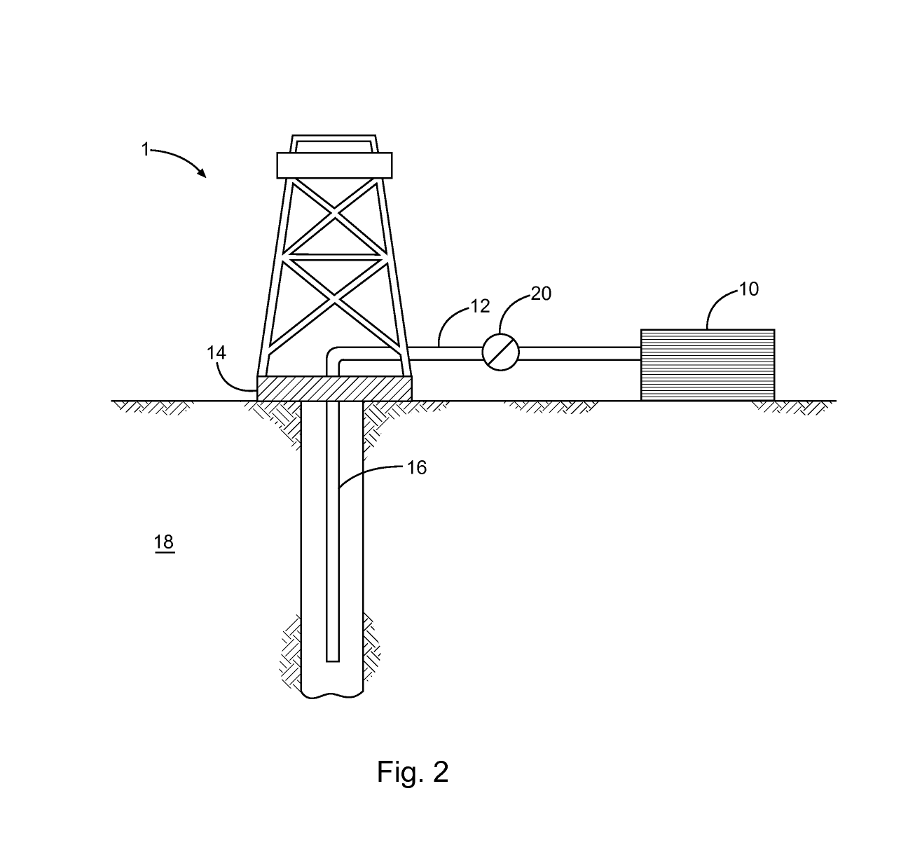

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the cellulose or cellulose derivative including grafted groups therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include a cellulose or cellulose derivative, the cellulose or cellulose derivative including grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

In some embodiments, the composition is a composition for fracturing of a subterranean formation or subterranean material, or a fracturing fluid. In some embodiments, the composition further includes a downhole fluid, such as a fracturing fluid.

In some embodiments, the composition includes a cellulose or cellulose derivative including repeating units having the structure:

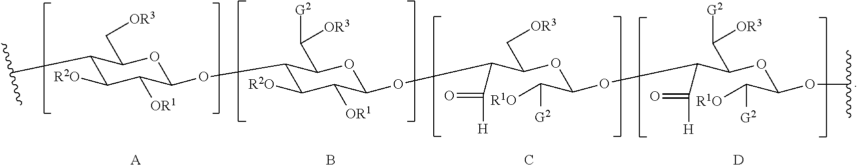

Repeating group A can be present in the cellulose or cellulose derivative in A mol %. Repeating group B can be present in the cellulose or cellulose derivative in B mol %. Repeating group C can be present in the cellulose or cellulose derivative in C mol %. Repeating group D can be present in the cellulose or cellulose derivative in D mol %. Repeating groups A, B, C, and D can be in random or block copolymer arrangement. The variables A mol %, B mol %, C mol %, and D mol % can each be independently about 0 mol % to about 99.999 mol %. At least one of B mol %, C mol %, and D mol % can be greater than 0 mol %. The variables R¹, R², and R³ can be each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted. At each occurrence, G¹ and G² can each independently include a unit having the structure:

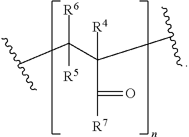

At each occurrence, the unit in G¹ or G² can independently occurs in the direction shown or in the opposite direction. At each occurrence, R⁴, R⁵, R⁶ can be independently chosen from —H and substituted or unsubstituted (C₁-C₁₀)hydrocarbyl. At each occurrence, R⁷ can be independently chosen from substituted or unsubstituted —NH₂, —OH or a salt or (C₁-C₁₀)hydrocarbyl ester thereof. At each occurrence n can be independently about 1 to about 100,000.

In various embodiments, the present invention provides a composition for treatment of a subterranean formation. The composition includes a cellulose or cellulose derivative having the structure:

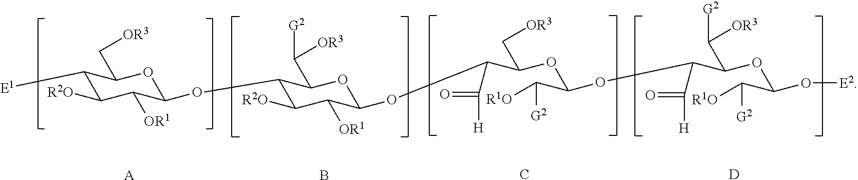

Repeating group A can be present in the cellulose or cellulose derivative in A mol %. Repeating group B can be present in the cellulose or cellulose derivative in B mol %. Repeating group C can be present in the cellulose or cellulose derivative in C mol %. Repeating group D can be present in the cellulose or cellulose derivative in D mol %. Repeating groups A, B, C, and D can be in random or block copolymer arrangement. The variables A mol %, B mol %, C mol %, and D mol % can be each independently about 0 mol % to about 99.999 mol %. At least one of B mol %, C mol %, and D mol % can be greater than 0 mol %. At each occurrence, G¹ and G² can each independently include a unit having the structure:

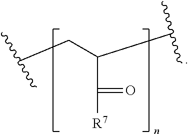

At each occurrence, the unit in G¹ or G² can independently occur in the direction shown or in the opposite direction. At each occurrence, R⁷ can be independently chosen from substituted or unsubstituted —NH₂, —OH or a salt or (C₁-C₁₀)hydrocarbyl ester thereof. At each occurrence n can be independently about 1 to about 100,000. The variable E¹ can have the structure:

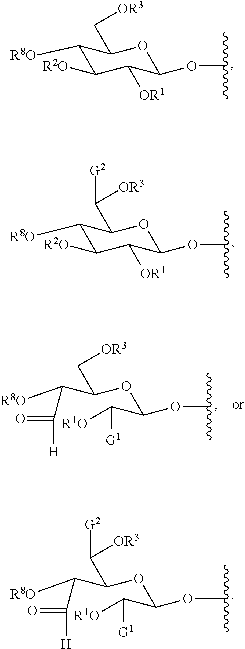

The variable E² can have the structure:

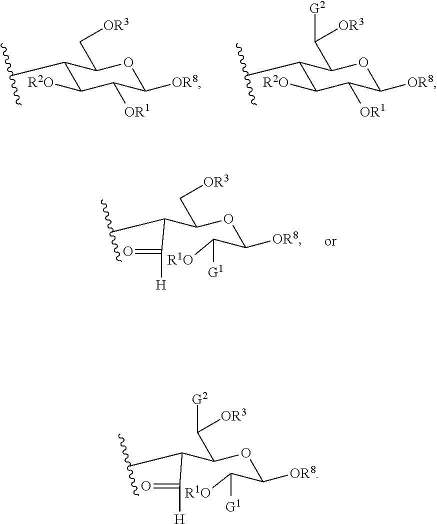

At each occurrence, R¹, R², R³, and R⁸ can be each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including a cellulose or cellulose derivative, the cellulose or cellulose derivative including grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof, such as any cellulose or cellulose derivative including grafted groups described herein.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

placing in the subterranean formation a composition comprising a cellulose or cellulose derivative, the cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

Embodiment 2 provides the method of Embodiment 1, wherein the method further comprises obtaining or providing the composition, wherein the obtaining or providing of the composition occurs above-surface.

Embodiment 3 provides the method of any one of Embodiments 1-2, wherein the method further comprises obtaining or providing the composition, wherein the obtaining or providing of the composition occurs in the subterranean formation.

Embodiment 4 provides the method of any one of Embodiments 1-3, wherein the composition is a fracturing fluid.

Embodiment 5 provides the method of any one of Embodiments 1-4, comprising fracturing the subterranean formation.

Embodiment 6 provides the method of any one of Embodiments 1-5, comprising fracturing the subterranean formation with the composition.

Embodiment 7 provides the method of any one of Embodiments 1-6, wherein about 0.01 wt % to about 50 wt % of the composition is the cellulose or cellulose derivative comprising the grafted groups.

Embodiment 8 provides the method of any one of Embodiments 1-7, wherein about 0.1 wt % to about 20 wt % of the composition is the cellulose or cellulose derivative comprising the grafted groups.

Embodiment 9 provides the method of any one of Embodiments 1-8, wherein in addition to the cellulose or cellulose derivative comprising the grafted groups, the composition comprises a cellulose or cellulose derivative.

Embodiment 10 provides the method of any one of Embodiments 1-9, wherein the cellulose or cellulose derivative comprising the grafted groups is at least one of a hydroxy(C₁-C₁₀)alkyl cellulose, a carboxy(C₁-C₁₀)alkyl cellulose or a salt or substituted or unsubstituted (C₁-C₁₀)hydrocarbyl ester thereof, a (C₁-C₁₀)alkyl cellulose, and an organic or inorganic ester derivative, wherein each (C₁-C₁₀)alkyl group is independently selected and is substituted or unsubstituted.

Embodiment 11 provides the method of any one of Embodiments 1-10, wherein the cellulose or cellulose derivative comprising the grafted groups is at least one of hydroxyethyl cellulose, hydroxypropyl cellulose, hydroxyethyl methyl cellulose, hydroxypropyl methyl cellulose, and ethyl hydroxyethyl cellulose.

Embodiment 12 provides the method of any one of Embodiments 1-11, wherein the cellulose or cellulose derivative comprising the grafted groups is at least one of carboxymethyl cellulose, hydroxyethyl carboxymethyl cellulose, carboxymethyl cellulose sodium salt, and hydroxyethyl carboxymethyl cellulose sodium salt.

Embodiment 13 provides the method of any one of Embodiments 1-12, wherein the cellulose or cellulose derivative comprising the grafted groups is at least one of methyl cellulose, ethyl cellulose, and ethyl methyl cellulose.

Embodiment 14 provides the method of any one of Embodiments 1-13, wherein the cellulose or cellulose derivative comprising the grafted groups is at least one of cellulose acetate, cellulose diacetate, cellulose triacetate, cellulose propionate, cellulose acetate propionate, cellulose acetate butyrate, cellulose acrylate, cellulose methacrylate, nitrocellulose, and cellulose sulfate.

Embodiment 15 provides the method of any one of Embodiments 1-14, wherein the cellulose or cellulose derivative comprising the grafted groups is prepared via a method comprising treating a cellulose or cellulose derivative with at least one of a redox initiator, a free radical initiator, radiation, and microwave irradiation.

Embodiment 16 provides the method of any one of Embodiments 1-15, wherein the cellulose or cellulose derivative comprising the grafted groups is prepared via a method comprising treating a cellulose or cellulose derivative with at least one of ceric ammonium nitrate, ceric ammonium sulfate, iron(II)-hydrogen peroxide, a Co(III) acetylacetonate complex salt, Co(II)-potassium monopersulfate, sodium sulfite-ammonium persulfate, azobisisobutyronitrile, potassium persulfate, and ammonium persulfate.

Embodiment 17 provides the method of any one of Embodiments 1-16, wherein the cellulose or cellulose derivative comprising the grafted groups is prepared via a method comprising treating a cellulose or cellulose derivative with a ceric(IV) ion.

Embodiment 18 provides the method of any one of Embodiments 1-17, wherein the cellulose or cellulose derivative comprising the grafted groups is prepared via a method comprising treating a cellulose or cellulose derivative with at least one of ceric ammonium nitrate and ceric ammonium sulfate.

Embodiment 19 provides the method of any one of Embodiments 1-18, wherein the cellulose or cellulose derivative comprising the grafted groups comprises a repeating unit having the structure:

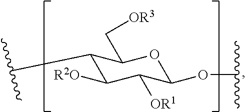

wherein at each occurrence, R¹, R², and R³ are each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted.

Embodiment 20 provides the method of Embodiment 19, wherein R¹, R², and R³ are each independently chosen from —H, (C₁-C₆)hydrocarbyl, —(C₁-C₆)hydrocarbyl-OH, —C(O)—(C₁-C₆)hydrocarbyl, —(C₁-C₆)hydrocarbylene-C(O)OH or a salt or a (C₁-C₆)hydrocarbyl ester thereof, —NO₂, —S(O)₂—OH or a salt or a (C₁-C₆)hydrocarbyl ester thereof, wherein each (C₁-C₆)hydrocarbyl and (C₁-C₆)hydrocarbylene is independently selected and is unsubstituted.

Embodiment 21 provides the method of any one of Embodiments 19-20, wherein R¹, R², and R³ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)hydrocarbyl is independently selected.

Embodiment 22 provides the method of any one of Embodiments 19-21, wherein R¹, R², and R³ are each —H.

Embodiment 23 provides the method of any one of Embodiments 1-22, wherein the cellulose or cellulose derivative comprising the grafted groups comprises a repeating unit having the structure:

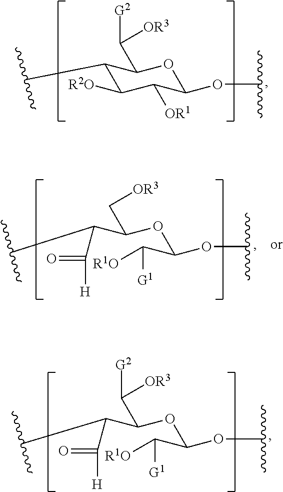

wherein

at each occurrence, R¹, R², and R³ are each independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof,

at each occurrence, G¹ and G² each independently comprise a unit having the structure:

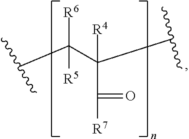

at each occurrence, the unit in G¹ or G² independently occurs in the direction shown or in the opposite direction,

at each occurrence, R⁴, R⁵, R⁶ are independently chosen from —H and substituted or unsubstituted (C₁-C₁₀)hydrocarbyl,

at each occurrence, R⁷ is independently chosen from substituted or unsubstituted —NH₂, —OH or a salt or (C₁-C₁₀)hydrocarbyl ester thereof,

at each occurrence n is independently about 1 to about 100,000, and

each (C₁-C₁₀)hydrocarbyl and (C₁-C₁₀)hydrocarbylene is independently selected and is substituted or unsubstituted.

Embodiment 24 provides the method of Embodiment 23, wherein R¹, R², and R³ are each independently chosen from —H, (C₁-C₆)hydrocarbyl, —(C₁-C₆)hydrocarbyl-OH, —C(O)—(C₁-C₆)hydrocarbyl, —(C₁-C₆)hydrocarbylene-C(O)OH or a salt or a (C₁-C₆)hydrocarbyl ester thereof, —NO₂, —S(O)₂—OH or a salt or a (C₁-C₆)hydrocarbyl ester thereof, wherein each (C₁-C₆)hydrocarbyl and (C₁-C₆)hydrocarbylene is independently selected and is unsubstituted.

Embodiment 25 provides the method of any one of Embodiments 23-24, wherein R¹, R², and R³ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

Embodiment 26 provides the method of any one of Embodiments 23-25, wherein R¹, R², and R³ are each —H.

Embodiment 27 provides the method of any one of Embodiments 23-26, wherein at each occurrence, G¹ and G² each independently have the structure:

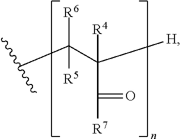

wherein at each occurrence the unit occurs in the direction shown or in the opposite direction.

Embodiment 28 provides the method of any one of Embodiments 23-27, wherein at each occurrence, R⁴, R⁵, R⁶ are independently chosen from —H and (C₁-C₆)hydrocarbyl.

Embodiment 29 provides the method of any one of Embodiments 23-28, wherein at each occurrence, R⁴, R⁵, R⁶ are independently chosen from —H and (C₁-C₃)alkyl.

Embodiment 30 provides the method of any one of Embodiments 23-29, wherein at each occurrence, R⁴, R⁵, R⁶ are —H.

Embodiment 31 provides the method of any one of Embodiments 23-30, wherein at each occurrence, R⁷ is independently chosen from —NH₂, —OH or a salt thereof.

Embodiment 32 provides the method of any one of Embodiments 23-31, wherein at each occurrence, R⁷ is —NH₂.

Embodiment 33 provides the method of any one of Embodiments 23-32, wherein the cellulose or cellulose derivative comprising the grafted groups comprises a repeating unit having the structure:

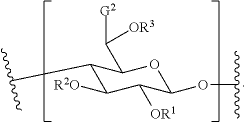

Embodiment 34 provides the method of any one of Embodiments 23-33, wherein the cellulose or cellulose derivative comprising the grafted groups comprises a repeating unit having the structure:

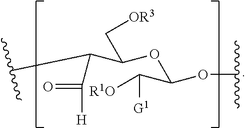

Embodiment 35 provides the method of any one of Embodiments 23-34, wherein the cellulose or cellulose derivative comprising the grafted groups comprises a repeating unit having the structure:

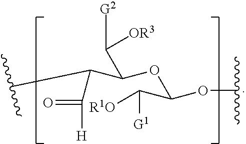

Embodiment 36 provides the method of any one of Embodiments 23-35, wherein the cellulose or cellulose derivative comprising the grafted groups comprises repeating units having the structure:

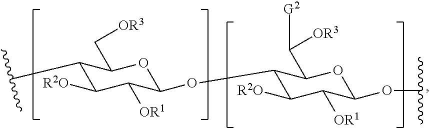

wherein the repeating units are in a block or random arrangement.

Embodiment 37 provides the method of any one of Embodiments 23-36, wherein the cellulose or cellulose derivative comprising the grafted groups comprises repeating units having the structure:

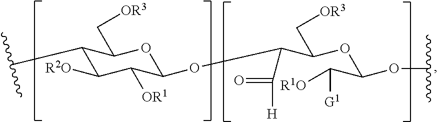

wherein the repeating units are in a block or random arrangement.

Embodiment 38 provides the method of any one of Embodiments 23-37, wherein the cellulose or cellulose derivative comprising the grafted groups comprises repeating units having the structure:

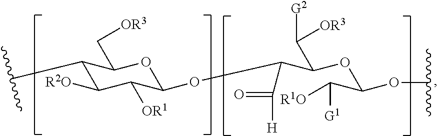

wherein the repeating units are in a block or random arrangement.

Embodiment 39 provides the method of any one of Embodiments 23-38, wherein the cellulose or cellulose derivative comprising the grafted groups has the structure:

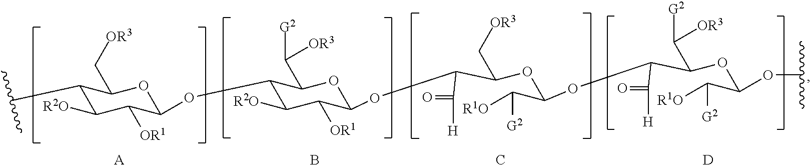

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement, A mol %, B mol %, C mol %, and D mol % are each independently about 0 mol % to about 99.999 mol %, and

at least one of B mol %, C mol %, and D mol % is greater than 0 mol %.

Embodiment 40 provides the method of any one of Embodiments 23-39, wherein the cellulose or cellulose derivative terminates in the groups E¹- and -E², wherein E¹ has the structure:

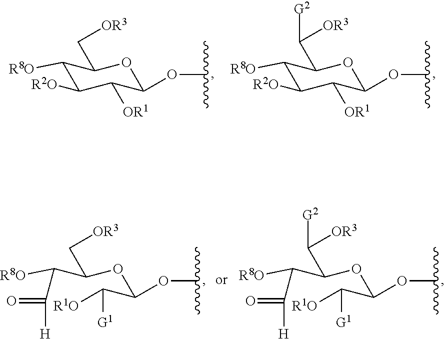

wherein E² has the structure:

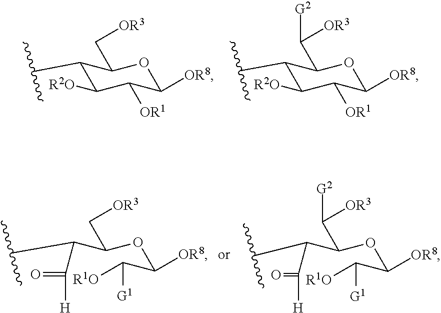

wherein at each occurrence R⁸ is independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted.

Embodiment 41 provides the method of Embodiment 40, wherein at each occurrence R⁸ is independently chosen from —H, (C₁-C₆)hydrocarbyl, —(C₁-C₆)hydrocarbyl-OH, —C(O)—(C₁-C₆)hydrocarbyl, —(C₁-C₆)hydrocarbylene-C(O)OH or a salt or a (C₁-C₆)hydrocarbyl ester thereof, —NO₂, —S(O)₂—OH or a salt or a (C₁-C₆)hydrocarbyl ester thereof, wherein each (C₁-C₆)hydrocarbyl and (C₁-C₆)hydrocarbylene is independently selected and is unsubstituted.

Embodiment 42 provides the method of any one of Embodiments 40-41, wherein at each occurrence R⁸ is independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

Embodiment 43 provides the method of any one of Embodiments 40-42, wherein R⁸ is —H.

Embodiment 44 provides the method of any one of Embodiments 40-43, wherein the cellulose or cellulose derivative comprising the grafted groups has the structure:

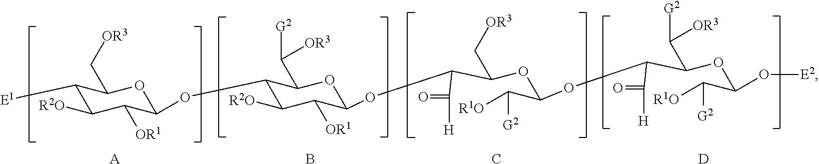

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement,

A mol %, B mol %, C mol %, and D mol % are each independently about 0 mol % to about 99.999 mol %, and

at least one of B mol %, C mol %, and D mol % is greater than 0 mol %.

Embodiment 45 provides the method of any one of Embodiments 1-44, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the composition in the subterranean formation comprises placing the mixture in the subterranean formation.

Embodiment 46 provides the method of any one of Embodiments 1-45, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

Embodiment 47 provides the method of any one of Embodiments 1-46, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 48 provides the method of any one of Embodiments 1-47, wherein the composition further comprises a proppant, a resin-coated proppant, or a combination thereof.

Embodiment 49 provides the method of any one of Embodiments 1-48, wherein the placing of the composition in the subterranean formation comprises pumping the composition through a tubular disposed in a wellbore and into the subterranean formation.

Embodiment 50 provides a system for performing the method of any one of Embodiments 1-49, the system comprising:

a tubular disposed in the subterranean formation; and

a pump configured to pump the composition in the subterranean formation through the tubular.

Embodiment 51 provides a method of treating a subterranean formation, the method comprising:

placing in the subterranean formation a composition comprising a cellulose or cellulose derivative comprising repeating units having the structure:

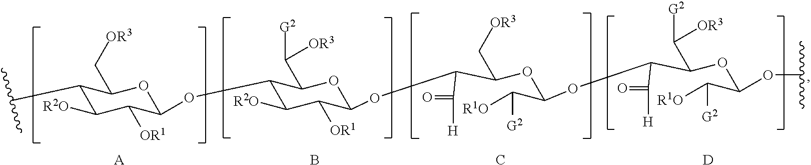

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement,

A mol %, B mol %, C mol %, and D mol % are each independently about 0 mol % to about 99.999 mol %,

at least one of B mol %, C mol %, and D mol % is greater than 0 mol %,

R¹, R², and R³ are each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted,

at each occurrence, G¹ and G² each independently comprise a unit having the structure:

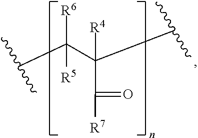

at each occurrence, the unit in G¹ or G² independently occurs in the direction shown or in the opposite direction,

at each occurrence, R⁴, R⁵, R⁶ are independently chosen from —H and substituted or unsubstituted (C₁-C₁₀)hydrocarbyl,

at each occurrence, R⁷ is independently chosen from substituted or unsubstituted —NH₂, —OH or a salt or (C₁-C₁₀)hydrocarbyl ester thereof, and

at each occurrence n is independently about 1 to about 100,000.

Embodiment 52 provides a method of treating a subterranean formation, the method comprising:

placing in the subterranean formation a composition comprising a cellulose or cellulose derivative having the structure:

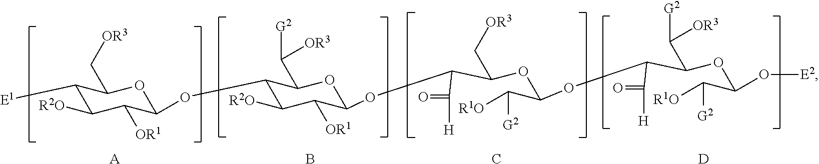

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement,

A mol %, B mol %, C mol %, and D mol % are each independently about 0 mol % to about 99.999 mol %,

at least one of B mol %, C mol %, and D mol % is greater than 0 mol %,

at each occurrence, G¹ and G² each independently comprise a unit having the structure:

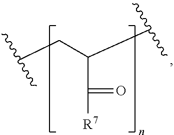

at each occurrence, the unit in G¹ or G² independently occurs in the direction shown or in the opposite direction,

at each occurrence, R⁷ is independently chosen from substituted or unsubstituted —NH₂, —OH or a salt or (C₁-C₁₀)hydrocarbyl ester thereof,

at each occurrence n is independently about 1 to about 100,000,

E¹ has the structure:

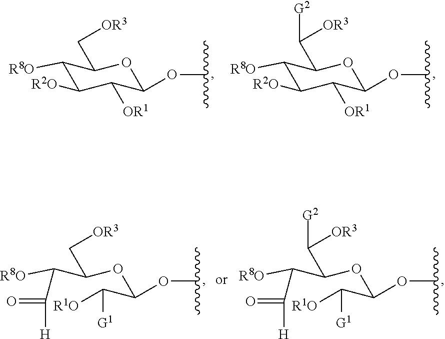

E² has the structure:

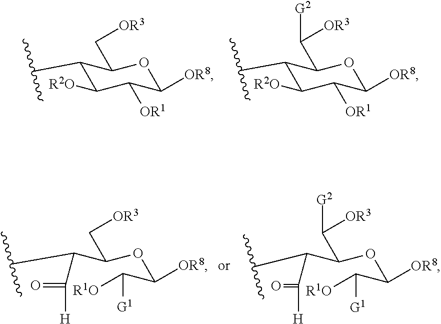

at each occurrence, R¹, R², R³, and R⁸ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

Embodiment 53 provides a system comprising:

a composition comprising a cellulose or cellulose derivative, the cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof; and

a subterranean formation comprising the composition therein.

Embodiment 54 provides the system of Embodiment 53, further comprising

a tubular disposed in the subterranean formation; and

a pump configured to pump the composition in the subterranean formation through the tubular.

Embodiment 55 provides a composition for treatment of a subterranean formation, the composition comprising:

a cellulose or cellulose derivative, the cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

Embodiment 56 provides the composition of Embodiment 55, wherein the composition is a composition for fracturing of a subterranean formation.

Embodiment 57 provides a composition for treatment of a subterranean formation, the composition comprising:

a cellulose or cellulose derivative comprising repeating units having the structure:

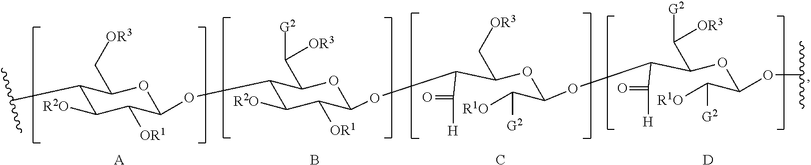

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement,

A mol %, B mol %, C mol %, and D mol % are each independently about 0 mol % to about 99.999 mol %,

at least one of B mol %, C mol %, and D mol % is greater than 0 mol %,

R¹, R², and R³ are each independently chosen from —H, (C₁-C₁₀)hydrocarbyl, —(C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof, wherein each (C₁-C₁₀)hydrocarbyl and (C₁-C₁₀)hydrocarbylene is independently selected and is substituted or unsubstituted,

at each occurrence, G¹ and G² each independently comprise a unit having the structure:

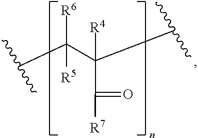

at each occurrence, the unit in G¹ or G² independently occurs in the direction shown or in the opposite direction,

at each occurrence, R⁴, R⁵, R⁶ are independently chosen from —H and substituted or unsubstituted (C₁-C₁₀)hydrocarbyl,

at each occurrence, R⁷ is independently chosen from substituted or unsubstituted —NH₂, —OH or a salt or (C₁-C₁₀)hydrocarbyl ester thereof, and at each occurrence n is independently about 1 to about 100,000.

Embodiment 58 provides a composition for treatment of a subterranean formation, the composition comprising:

a cellulose or cellulose derivative having the structure:

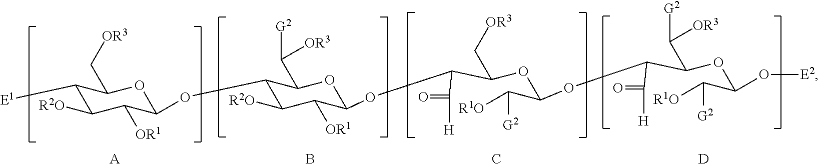

wherein

repeating group A is present in the cellulose or cellulose derivative in A mol %,

repeating group B is present in the cellulose or cellulose derivative in B mol %,

repeating group C is present in the cellulose or cellulose derivative in C mol %,

repeating group D is present in the cellulose or cellulose derivative in D mol %,

repeating groups A, B, C, and D are in random or block copolymer arrangement,

A mol %, B mol %, C mol %, and D mol % are each independently about 0 mol % to about 99.999 mol %,

at least one of B mol %, C mol %, and D mol % is greater than 0 mol %,

at each occurrence, G¹ and G² each independently comprise a unit having the structure:

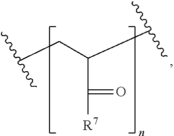

at each occurrence, the unit in G¹ or G² independently occurs in the direction shown or in the opposite direction,

at each occurrence, R⁷ is independently chosen from substituted or unsubstituted —NH₂, —OH or a salt or (C₁-C₁₀)hydrocarbyl ester thereof,

at each occurrence n is independently about 1 to about 100,000,

E¹ has the structure:

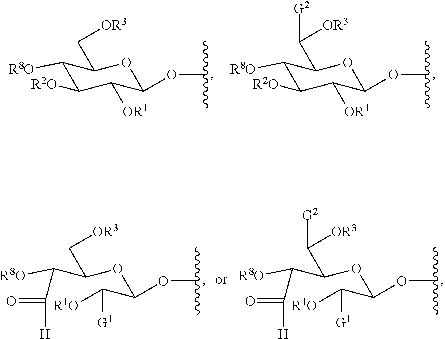

E² has the structure:

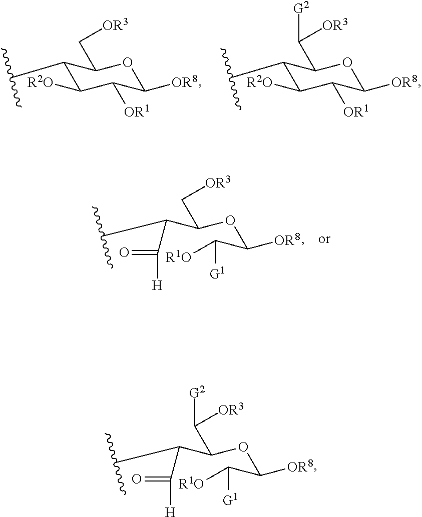

at each occurrence, R¹, R², R³, and R⁸ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

Embodiment 59 provides a method of preparing a composition for treatment of a subterranean formation, the method comprising:

forming a composition comprising a cellulose or cellulose derivative, the cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof.

Embodiment 60 provides the composition, apparatus, method, or system of any one or any combination of Embodiments 1-59 optionally configured such that all elements or options recited are available to use or select from.

1.-59. (canceled)

60. A method of treating a subterranean formation, comprising:
placing a composition into the subterranean formation, the composition comprising a cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof,
wherein the cellulose or cellulose derivative comprising the grafted groups is prepared via a method comprising treating a cellulose or cellulose derivative with at least one of a redox initiator, a free radical initiator, radiation, microwave irradiation, or combinations thereof.

61. The method of claim 60, further comprising fracturing the subterranean formation with the composition, wherein the composition further comprises a proppant, and wherein about 0.1 wt % to about 20 wt % of the composition is the cellulose or cellulose derivative comprising the grafted groups.

62. The method of claim 60, wherein the cellulose or cellulose derivative comprising the grafted groups is at least one of carboxymethyl cellulose, hydroxyethyl carboxymethyl cellulose, carboxymethyl cellulose sodium salt, hydroxyethyl carboxymethyl cellulose sodium salt, cellulose acetate, cellulose diacetate, cellulose triacetate, cellulose propionate, cellulose acetate propionate, cellulose acetate butyrate, cellulose acrylate, cellulose methacrylate, nitrocellulose, cellulose sulfate, or combinations thereof.

63. The method of claim 60, wherein the cellulose or cellulose derivative comprising the grafted groups is prepared via a method comprising treating a cellulose or cellulose derivative with at least one of ceric ammonium nitrate, ceric ammonium sulfate, iron(II)-hydrogen peroxide, a cobalt(III) acetylacetonate complex salt, cobalt(II)-potassium monopersulfate, sodium sulfite-ammonium persulfate, azobisisobutyronitrile, potassium persulfate, ammonium persulfate, or combinations thereof.

64. The method of claim 60, wherein the cellulose or cellulose derivative comprising the grafted groups is prepared via a method comprising treating a cellulose or cellulose derivative with a cerium(IV) ion.

65. The method of claim 60, wherein the cellulose or cellulose derivative comprising the grafted groups is prepared via a method comprising treating a cellulose or cellulose derivative with ceric ammonium nitrate, ceric ammonium sulfate, or a combination thereof.

66. The method of claim 60, wherein the cellulose or cellulose derivative comprising the grafted groups comprises a repeating unit having the structure: 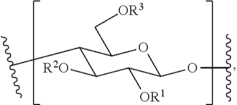
wherein at each occurrence, R¹, R², and R³ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)hydrocarbyl is independently selected.

67. The method of claim 60, wherein the cellulose or cellulose derivative comprising the grafted groups comprises a repeating unit having the structure: 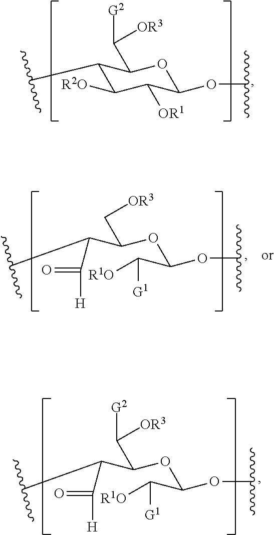
wherein
at each occurrence, R¹, R², and R³ are each independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof,
at each occurrence, G¹ and G² each independently comprises a unit having the structure: 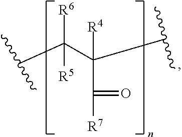
wherein:
at each occurrence, the unit in G¹ or G² independently occurs in the direction shown or in the opposite direction,
at each occurrence, R⁴, R⁵, R⁶ are independently chosen from —H and substituted or unsubstituted (C₁-C₁₀)hydrocarbyl,
at each occurrence, R⁷ is independently chosen from substituted or unsubstituted —NH₂, —OH or a salt or (C₁-C₁₀)hydrocarbyl ester thereof,
at each occurrence n is independently about 1 to about 100,000, and
each (C₁-C₁₀)hydrocarbyl and (C₁-C₁₀)hydrocarbylene is independently selected and is substituted or unsubstituted.

68. The method of claim 67, wherein R¹, R², and R³ are each independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, —S(O)₂—OH or a salt or a (C₁-C₃)alkyl ester thereof, wherein each (C₁-C₃)alkyl is independently selected.

69. The method of claim 67, wherein at each occurrence, G¹ and G² each independently have the structure: 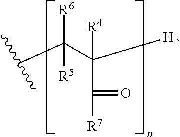
wherein at each occurrence the unit occurs in the direction shown or in the opposite direction.

70. The method of claim 67, wherein at each occurrence, R⁴, R⁵, R⁶ are independently chosen from —H and (C₁-C₃)alkyl, and wherein at each occurrence, R⁷ is independently chosen from —NH₂, —OH or a salt thereof.

71. The method of claim 67, wherein the cellulose or cellulose derivative comprising the grafted groups comprises a repeating unit having the structure:

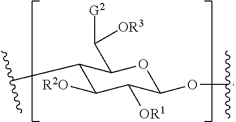

72. The method of claim 67, wherein the cellulose or cellulose derivative comprising the grafted groups comprises a repeating unit having the structure:

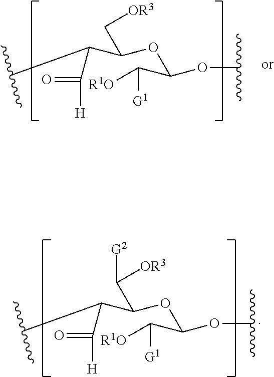

73. The method of claim 67, wherein the cellulose or cellulose derivative comprising the grafted groups comprises repeating units having the structure: 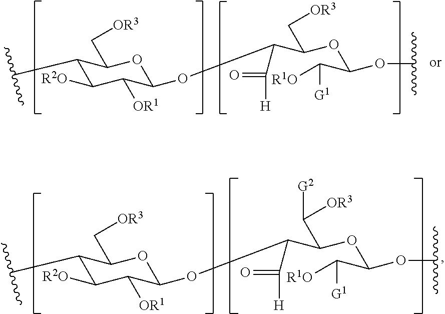
wherein the repeating units are in a block or random arrangement.

74. The method of claim 67, wherein the cellulose or cellulose derivative comprising the grafted groups has the structure: 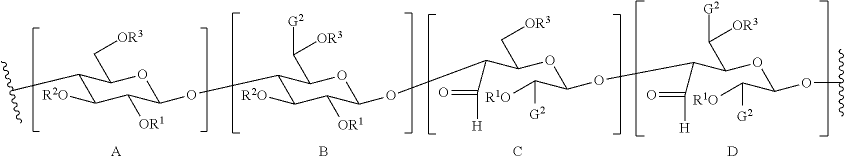
wherein:
repeating group A is present in the cellulose or cellulose derivative in A mol %,
repeating group B is present in the cellulose or cellulose derivative in B mol %,
repeating group C is present in the cellulose or cellulose derivative in C mol %,
repeating group D is present in the cellulose or cellulose derivative in D mol %,
repeating groups A, B, C, and D are in random or block copolymer arrangement,
A mol %, B mol %, C mol %, and D mol % are each independently about 0 mol % to about 99.999 mol %, and
at least one of B mol %, C mol %, or D mol % is greater than 0 mol %.

75. The method of claim 67, wherein the cellulose or cellulose derivative terminates in the groups E¹- and -E², wherein E¹ has the structure: 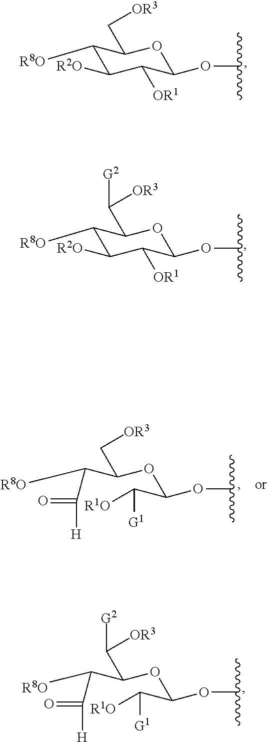
wherein E² has the structure: 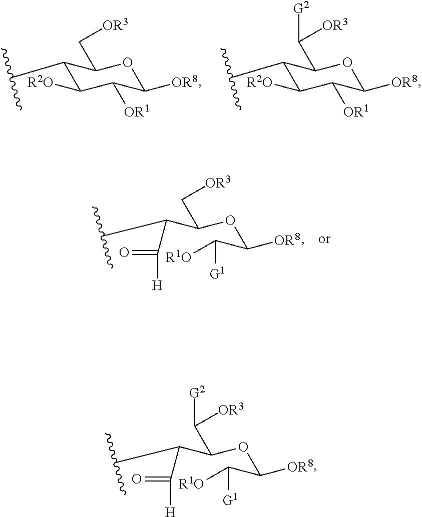
wherein at each occurrence R⁸ is independently chosen from —H, (C₁-C₃)alkyl, —(C₁-C₃)alkyl-OH, —C(O)—(C₁-C₃)alkyl, —(C₁-C₃)alkylene-C(O)OH or a salt or a (C₁-C₃)alkyl ester thereof, —NO₂, or —S(O)₂—OH or a salt or a (C₁-C₃)alkyl ester thereof, wherein each (C₁-C₃)alkyl is independently selected.

76. The method of claim 75, wherein the cellulose or cellulose derivative comprising the grafted groups has the structure: 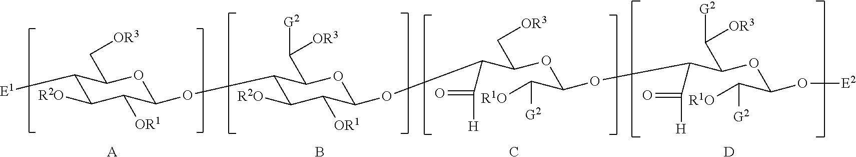
wherein
repeating group A is present in the cellulose or cellulose derivative in A mol %,
repeating group B is present in the cellulose or cellulose derivative in B mol %,
repeating group C is present in the cellulose or cellulose derivative in C mol %,
repeating group D is present in the cellulose or cellulose derivative in D mol %,
repeating groups A, B, C, and D are in random or block copolymer arrangement,
A mol %, B mol %, C mol %, and D mol % are each independently about 0 mol % to about 99.999 mol %, and
at least one of B mol %, C mol %, or D mol % is greater than 0 mol %.

77. A system for performing the method of claim 60, the system comprising:
a tubular disposed in the subterranean formation; and
a pump configured to pump the composition in the subterranean formation through the tubular.

78. A method of treating a subterranean formation, comprising:
placing a composition into the subterranean formation, the composition comprising a cellulose or cellulose derivative, the cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof,
wherein the cellulose or cellulose derivative comprising the grafted groups comprises a repeating unit having the structure: 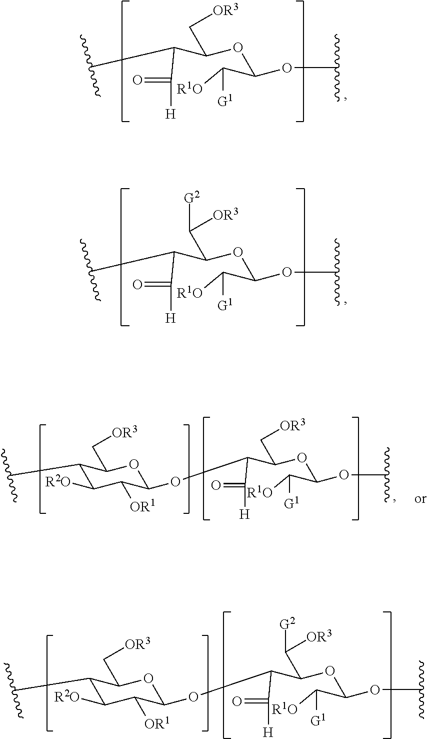
wherein:
at each occurrence, R¹, R², and R³ are each independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof,
at each occurrence, G¹ and G² each independently comprises a unit having the structure: 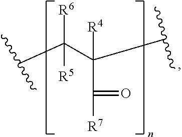
wherein:
at each occurrence, the unit in G or G² independently occurs in the direction shown or in the opposite direction,
at each occurrence, R⁴, R⁵, R⁶ are independently chosen from —H and substituted or unsubstituted (C₁-C₁₀)hydrocarbyl,
at each occurrence, R⁷ is independently chosen from substituted or unsubstituted —NH₂, —OH or a salt or (C₁-C₁₀)hydrocarbyl ester thereof,
at each occurrence n is independently about 1 to about 100,000, and
each (C₁-C₁₀)hydrocarbyl and (C₁-C₁₀)hydrocarbylene is independently selected and is substituted or unsubstituted.

79. A composition, comprising:
a cellulose or cellulose derivative comprising grafted groups selected from the group consisting of a) grafted acrylamide groups, b) grafted acrylic acid groups or a salt or a substituted or unsubstituted (C₁-C₁₀)hydrocarbyl ester thereof, and c) a combination thereof,
wherein the cellulose or cellulose derivative comprising the grafted groups comprises a repeating unit having the structure: 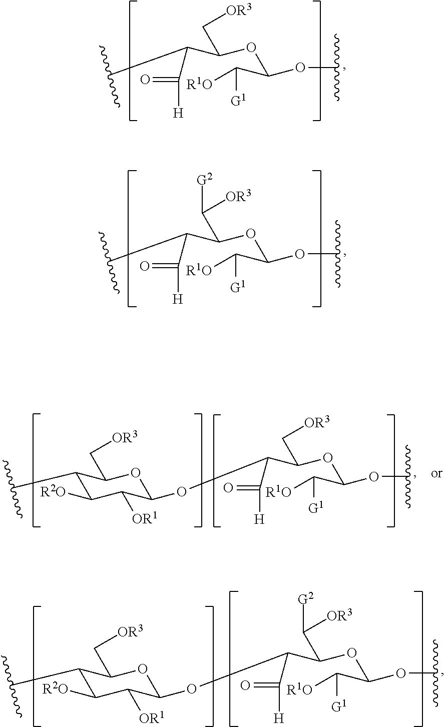
wherein:
at each occurrence, R¹, R², and R³ are each independently chosen from —H, (C₁-C₁₀)hydrocarbyl, (C₁-C₁₀)hydrocarbyl-OH, —C(O)—(C₁-C₁₀)hydrocarbyl, —(C₁-C₁₀)hydrocarbylene-C(O)OH or a salt or a (C₁-C₁₀)hydrocarbyl ester thereof, —NO₂, —S(O)₂—OH or a salt or a (C₁-C₁₀)hydrocarbyl ester thereof,
at each occurrence, G¹ and G² each independently comprises a unit having the structure: 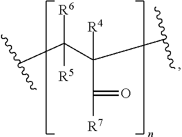
wherein:
at each occurrence, the unit in G¹ or G² independently occurs in the direction shown or in the opposite direction,
at each occurrence, R⁴, R⁵, R⁶ are independently chosen from —H and substituted or unsubstituted (C₁-C₁₀)hydrocarbyl,
at each occurrence, R⁷ is independently chosen from substituted or unsubstituted —NH₂, —OH or a salt or (C₁-C₁₀)hydrocarbyl ester thereof,
at each occurrence n is independently about 1 to about 100,000, and
each (C₁-C₁₀)hydrocarbyl and (C₁-C₁₀)hydrocarbylene is independently selected and is substituted or unsubstituted.
